(19) United States
(12) Patent Application Publication
(10) Pub. No.: US 2020/0363064 A1
(43) Pub. Date: Nov. 19, 2020

(54) COMBUSTION CHAMBER ASSEMBLY WITH COMBUSTION CHAMBER MEMBER AND SHINGLE MEMBER WITH HOLES FOR A MIXED AIR HOLE ATTACHED THERETO

(71) Applicant: Rolls-Royce Deutschland Ltd & Co KG, Blankenfelde-Mahlow (DE)

(72) Inventor: Miklos GERENDAS, Am Mellensee (DE)

(21) Appl. No.: 16/863,355

(22) Filed: Apr. 30, 2020

(30) Foreign Application Priority Data
May 13, 2019 (DE) 10 2019 112 442.5

(51) Int. Cl. F23R 3/04; F23R 3/00

(52) U.S. Cl. CPC F23R 3/04; F05D 2240/35; F23R 3/002

(57) ABSTRACT

A combustion chamber assembly for an engine includes one combustion chamber component of a combustion chamber structure surrounding a combustion space, and one shingle component fixed on the combustion chamber component and having a hot side facing the combustion space and a cold side facing away from the combustion space and towards the combustion chamber component. A mixing air hole formed by a through hole in the combustion chamber component and a shingle hole in the shingle component feeds mixing air into the combustion space. The through hole defines an inlet opening for mixing air on an outer side of the combustion chamber component, and, on the hot side, the shingle hole defines an outlet opening for mixing air flowing in via the inlet opening. The through hole is provided eccentrically with respect to the shingle hole, based on a central point of the outlet opening.

This application claims priority to German Patent Application DE102019112442.5 filed May 13, 2019, the entirety of which is incorporated by reference herein.

The proposed solution relates to a combustion chamber assembly for an engine.

A proposed combustion chamber assembly for an engine basically comprises at least one combustion chamber component of a combustion chamber structure surrounding a combustion space, and a shingle component, which is fixed on the combustion chamber component and has a hot side facing toward the combustion space and a cold side facing away from the combustion space and facing the combustion chamber component. The combustion chamber component can be a combustion chamber wall for a combustion chamber of the engine, for example. At least one mixing air hole is provided for feeding mixing air into the combustion space. Such a mixing air hole is formed, on the one hand, by a through hole in the combustion chamber component and, on the other hand, by a shingle hole in the shingle component. The through hole defines an inflow opening for mixing air on an outer side of the combustion chamber component, while the shingle hole defines, on the hot side of the shingle component, an outlet opening for mixing air flowing in via the inlet opening of the through hole. The mixing air hole is thus defined by the through hole in the combustion chamber component and the shingle hole in the shingle component.

In the case of combustion chamber assemblies known from the prior art, both the through hole and the shingle hole are typically defined geometrically by a right cylinder, in particular by a right circular cylinder. In this context, provision has already been made in EP 1 351 022 A1 to select significantly larger dimensions, in particular a significantly larger diameter, for a through hole in the combustion chamber component than for a shingle hole, arranged concentrically with the through hole, in a shingle component.

In practice, it has now been found that the transverse approach flow to the mixing air hole on the outer side of the combustion chamber component may lead to separation of the mixing air flow on an upstream side of an outlet opening of the mixing air hole. As a result, combustion products from the combustion space may reach an upstream part of an inner wall and hence an inner circumferential surface of the shingle hole. This, in turn, can lead to overheating and thus to damage of the shingle component, which in turn leads to a reduced life of the shingle component.

It is therefore the object of the proposed solution to further improve a combustion chamber assembly in this respect.

This object is achieved with a combustion chamber assembly according to claim 1 and with a combustion chamber assembly according to claim 18.

According to a first aspect, a combustion chamber assembly is proposed in which the through hole in the combustion chamber component is provided eccentrically with respect to the shingle hole in the shingle component, based on a central point of the outlet opening in the shingle component.

Thus, the through hole and the shingle hole follow one another along a central axis of the mixing air hole extending from an outer side of the combustion chamber component to the hot side of the shingle component, but are provided eccentrically with respect to one another. By virtue of the eccentricity of the through hole and of the shingle hole, which together define the at least one mixing air hole in the combustion chamber assembly, and by virtue of the associated asymmetry in the alignment, in particular, of the inflow opening in the combustion chamber component relative to the outlet opening on the hot side of the shingle component, it is possible to take account in an effective manner of asymmetry in the mixing air flow and hence in the inflow of mixing air into the mixing air hole. It has been found that the tendency of the mixing air flow for separation on the hot side of the shingle component can thereby be reduced. The result is a correspondingly increased life of the shingle component.

As a consequence of the eccentricity of the through hole and of the shingle hole, it is possible, in one design variant, for the central point of the outlet opening to be offset relative to a central point of the inflow opening in a flow direction in which mixing air is guided along the outer side of the combustion chamber component during the operation of the engine. The flow direction in which the mixing air is guided along the outer side of the combustion chamber component is typically parallel to a direction of extent of the combustion space in the correctly installed state of the combustion chamber assembly in an engine. Consequently, this is the direction of the flow in the “annulus” around the combustion chamber, for example. In contrast to previously known solutions, an offset between the central point of the outlet opening and the central point of the inflow opening thus starts, in particular, from a nominally changed position of the shingle hole in a flow direction away from a combustion chamber head of the combustion space in relation to the through hole in the combustion chamber component. Consequently, the result is an offset transverse to a longitudinal axis along which the mixing air hole extends through the combustion chamber component and the shingle component.

For example, the inflow opening on the outer side of the combustion chamber component is elliptical. As an alternative or in addition, the outlet opening on the hot side of the shingle component can be circular. In particular, an elliptical inflow opening can be combined with a circular outlet opening of smaller diameter. In this way, not only is there a change in the cross-sectional shape of the mixing air hole, starting from the through hole in the combustion chamber component to the outlet opening of the shingle hole in the shingle component. On the contrary, the cross section through which the mixing air has to flow is also reduced in the manner of a nozzle from the inflow opening to the outlet opening. In one design variant, a stepped reduction in cross section can be provided at the transition from the through hole to the shingle hole, for example.

In one design variant, the through hole is defined geometrically by a right cylinder. The shingle hole can likewise be defined by a right cylinder (formed with a central axis offset with respect to the cylinder of the through hole and optionally with different dimensions and base surfaces). Local rounded portions, oblique circumferential surface sections and/or chamfers are possible in this context. However, the basic shape of the through hole and of the shingle hole remains a right cylinder in this variant, and therefore an offset between the through hole and the shingle hole is not achieved by means of an oblique inner wall profile of the holes but by deliberate eccentric arrangement of the different holes in the combustion chamber component and the shingle component which jointly define the at least one mixing air hole. In a refinement, central axes of the two (right) cylinders are thus parallel to one another. The cylinder axes can, for example, each extend substantially perpendicular to the flow direction of mixing air guided along the outer side of the combustion chamber component.

In principle, the dimensions of the inflow opening with can be larger than the dimensions of an inlet opening defined by the shingle hole on the cold side of the shingle component. By virtue of the larger dimensioning of the inflow opening, it is possible on the cold side of the shingle component for a shingle component edge surface bounding the inlet opening to be at least in part not covered by the combustion chamber component at the inflow opening. The inflow opening of the combustion chamber component and the inlet opening of the shingle hole in the shingle component are thus not aligned with one another. On the contrary, there is an exposed overhang on the cold side of the shingle component by virtue of the edge surface. Consequently, this overhang of the shingle component can be impinged upon by mixing air flowing in the direction of the shingle hole via the inflow opening. By means of the edge surface and the overhang defined thereby, a step is provided within the mixing air hole, said hole reducing a flow cross section of the mixing air opening in a stepped manner at the transition from the combustion chamber component to the shingle component. A stepped transition of this kind can likewise improve the guidance of a mixing air flow in the direction of the outlet opening on the hot side of the shingle component.

For example, the edge surface of the shingle component which is not covered by the combustion chamber component at the inflow opening is designed with a greater width in an upstream region, based on a flow direction in which mixing air is guided along the outer side of the combustion chamber component during the operation of the engine, than in a downstream region. A design variant of this kind includes the possibility, for example, that the edge surface which is not covered by the combustion chamber component has an upstream first end and a downstream second end in a central cross section through the mixing air hole, i.e. a cross section passing through the central point of the inflow opening, and the edge surface which is not covered has its maximum width at the upstream end. The minimum width of the edge surface can then optionally be present at the downstream second end.

Although the formation of the edge surface with a minimum width in the region of a second end is not compulsory, one possible refinement can provide for the width of the edge surface which is not covered to decrease, in particular continuously, in a circumferential direction along the edge of the inlet opening (on the cold side of the shingle component) from the first end to the second end. In particular, this includes the possibility that the width of the edge surface which is not covered at the edge of the inlet opening is embodied so as to taper from the first end toward the second end.

In one exemplary embodiment, it has been found that certain geometrical relationships can be advantageous for the guidance of the mixing air flow at and in the mixing air hole. In this context, the width of the edge surface which is not covered then corresponds at the first end, for example, to at least twice a (mean) wall thickness of the combustion chamber component at the through hole. As an alternative or in addition, the width of the edge surface which is not covered at the second end corresponds to at least a (mean) wall thickness of the combustion chamber component at the through hole.

With a view to effective guidance of a mixing air flow at and in the mixing air hole, provision can be made, for example, for the shingle hole to define, on the cold side of the shingle component, an inlet opening at which mixing air can flow out of the through hole in the combustion chamber component into the shingle hole in the direction of the outlet opening, and for a feed bevel that guides a mixing air flow in the direction of the outlet opening to be formed on one edge of the inlet opening in the shingle component. By way of example, a feed bevel of this kind is formed by a chamfer on the edge of the inlet opening.

In one design variant, the feed bevel is designed with a greater width in an upstream region, based on a flow direction in which mixing air is guided along the outer side of the combustion chamber component during the operation of the engine, than in a downstream region.

Particularly the formation, as proposed above, of a feed bevel on an inlet opening of the shingle component can entail the advantage here, in particular, that a flow of mixing air (mixing air flow) clings well to an inner contour of the shingle hole. This reduces a tendency of the mixing air flow for separation on the hot side of the shingle component.

In principle, the feed bevel can be provided in such a way as to run around the circumference of the inlet opening of the shingle hole. Consequently, the feed bevel then extends along the entire circumference of an inlet opening.

In a refinement which builds on this, the feed bevel has an upstream first end and a downstream second end in a central cross section through the mixing air hole, i.e. a cross section passing through the central point of the inflow opening, and the feed bevel has its maximum width at the upstream end. The minimum width of the feed bevel can be in the direction of the second end or at the second end, e.g. in the circumferential direction.

As an alternative or in addition, a width of the feed bevel (on the cold side of the shingle component) can decrease in a circumferential direction along an edge of the inlet opening. This includes, in particular, that the feed bevel tapers in the circumferential direction, starting from a first end situated upstream in a central cross section through the mixing air hole. This can include, in particular, that the width of the feed bevel decreases in the circumferential direction from the first end to the second end, in particular continuously. A chamfer which defines the feed bevel or an entry radius, defining the feed bevel, on the cold side of the shingle component thus has the maximum extent at an upstream end and tapers from there in the direction of a downstream second end.

In one design variant, to (further) reduce the risk of separation of the mixing air flow as it emerges from the outlet opening on the hot side of the shingle component, it is envisaged that, in a central cross section through the mixing air hole, an upstream section of an inner wall of the shingle hole and an edge surface bounding the outlet opening on the hot side of the shingle component extend at an acute angle to one another in an upstream edge region of the outlet opening (based on a flow direction in which mixing air is guided along the outer side of the combustion chamber component during the operation of the engine). In an upstream edge region of the outlet opening, the inner wall and the edge surface on the hot side of the shingle component are consequently not oriented at an angle of 90°, but at an angle of <90°, to one another.

In one design variant, a rounded portion, which guides mixing air in the direction of the shingle hole, is formed on one edge of the inflow opening. Thus, an inward-facing rounded portion that runs at least partially or all the way around the circumference can be provided on one edge of the inflow opening in the combustion chamber component.

According to another aspect of the proposed solution, a combustion chamber assembly is provided in which a feed bevel, which guides a mixing air flow in the direction of the outlet opening in the shingle component, is formed on one edge of an inlet opening in the shingle component, which bevel has a greater width in an upstream region, based on a flow direction in which mixing air is guided along the outer side of the combustion chamber component during the operation of the engine, than in a downstream region.

As already explained above, a correspondingly asymmetrically configured feed bevel can take account of the asymmetry of the outer approach flow of mixing air to the mixing air hole. Accordingly, by means of the relatively large width of the upstream region of the feed bevel, a larger guide surface is provided at the inlet opening in the shingle component than in a downstream region of the shingle hole, said guide surface sloping and therefore facing inward.

The advantages explained above in connection with design variants, each having a feed bevel, of a combustion chamber assembly configured in accordance with the first aspect also apply to a combustion chamber assembly according to the second aspect. In particular, provision can be made for the feed bevel to be provided in such a way as to run around the circumference of the inlet opening of the shingle hole and thus to define a kind of inflow funnel at the inlet opening. As an alternative or in addition, provision can be made for a width of the feed bevel to decrease, in particular to decrease continuously, in a circumferential direction along the edge of the inlet opening, starting from a first end of the inlet opening that is situated upstream when seen in a central cross section, and thus for the feed bevel to taper, for example.

In principle, provision can furthermore be made (according to the first or second aspect of the proposed solution) for a combustion chamber assembly to have a spark plug for igniting a fuel-air mixture in the combustion space. In the combustion chamber assembly, an access opening through the combustion chamber component and the shingle component can be provided for the spark plug. If the access opening for the spark plug overlaps at least partially with a mixing air hole and a kind of keyhole contour is thereby formed, it is of course possible for the mixing air hole to be designed in accordance with the proposed solution. In a design variant of this kind, it is possible, in particular, to envisage that an edge surface which is not covered by the combustion chamber component on the cold side of the shingle component and a resulting overhang of the shingle component within the mixing air hole (beyond an edge of the inflow opening in the combustion chamber component) has a greater width at an upstream end than at a downstream end of the keyhole contour formed.

In principle, a plurality and, in particular, a multiplicity of mixing air openings configured as proposed can be provided in a proposed combustion chamber assembly.

The appended figures illustrate, by way of example, possible design variants of the proposed solution.

In the figures:

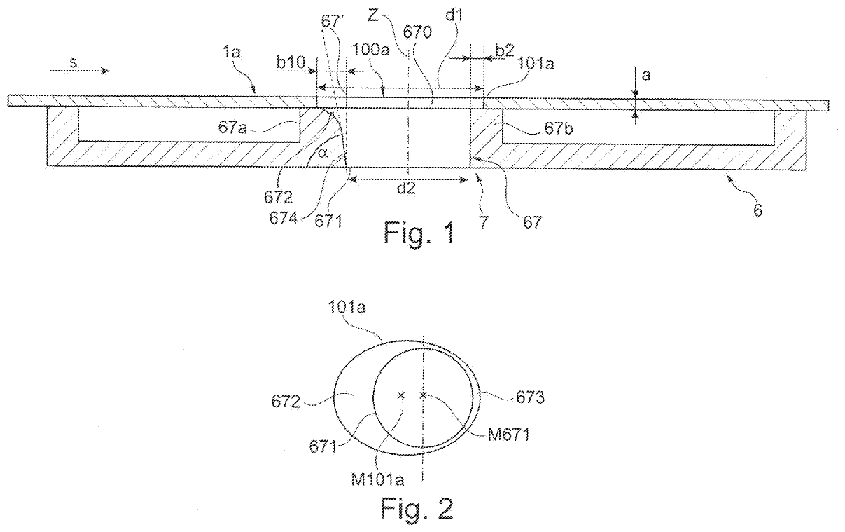

FIG. 1 shows, in a central cross section, a segment of a design variant of a proposed combustion chamber assembly having a mixing air hole, which is provided by asymmetrically configured holes provided eccentrically with respect to one another in a combustion chamber component designed as a combustion chamber wall and in a shingle component designed as a combustion chamber shingle;

FIG. 2 shows, in plan view, the cross-sectional areas of an inflow opening in the wall and an outlet opening in the shingle to illustrate the asymmetric configuration and eccentric arrangement;

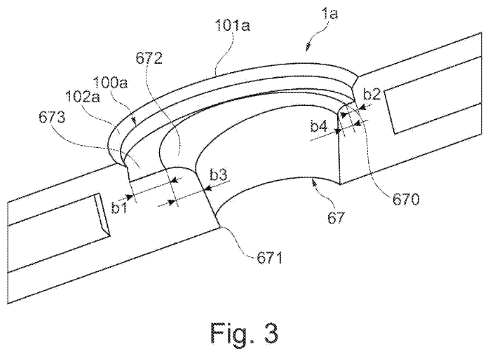

FIG. 3 shows, in a sectioned perspective view, a refinement of the design variant in FIGS. 1 and 2 with a perspective illustration of a feed bevel formed by a chamfer and running around the circumference of an inlet opening of the shingle hole, and an overhang of variable width extending along the inlet opening;

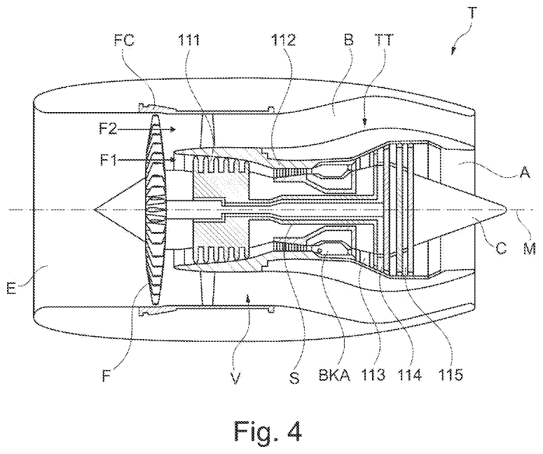

FIG. 4 shows an engine in which a combustion chamber assembly corresponding to FIGS. 1 to 3 is used;

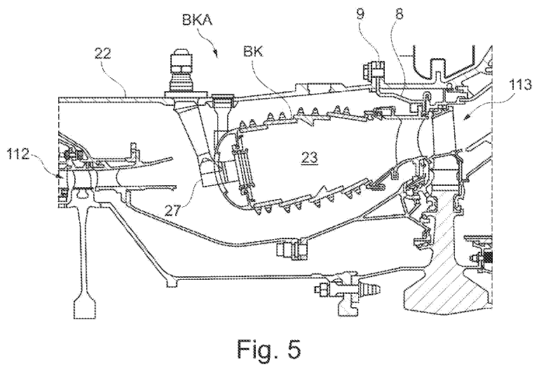

FIG. 5 shows, on an enlarged scale, a segment of a combustion chamber of the engine of FIG. 4;

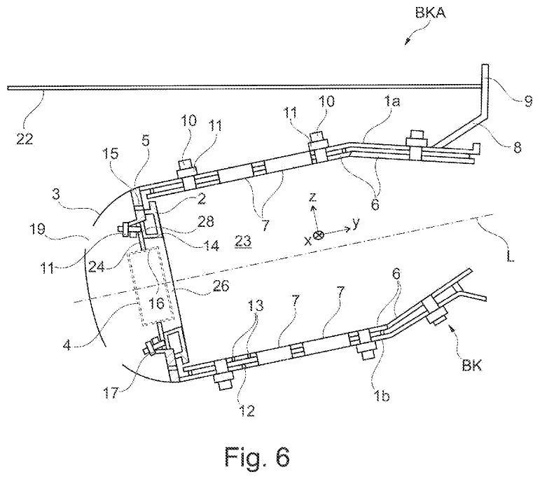

FIG. 6 shows, in cross-sectional view, the fundamental structure of a combustion chamber, again on an enlarged scale in comparison with FIG. 5;

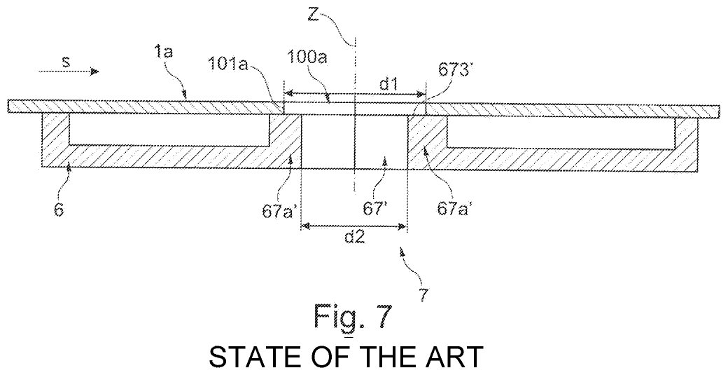

FIG. 7 shows, in a view corresponding to FIG. 1, a combustion chamber assembly from the prior art having a mixing air hole, which is formed by symmetrical holes, formed concentrically with one another, in the combustion chamber wall and a combustion chamber shingle.

FIG. 4 illustrates, schematically and in a sectional illustration, an engine T in which the individual engine components are arranged one behind the other along an axis of rotation or central axis M, and the engine T is formed as a turbofan engine. At an inlet or intake E of the engine T, air is drawn in along an inlet direction by means of a fan F. This fan F, which is arranged in a fan casing FC, is driven by means of a rotor shaft S which is set in rotation by a turbine TT of the engine T. Here, the turbine TT adjoins a compressor V, which comprises for example a low-pressure compressor 111 and a high-pressure compressor 112, and possibly also a medium-pressure compressor. On the one hand, the fan F conducts air in a primary air flow F1 to the compressor V, and, on the other hand, to generate thrust, in a secondary air flow F2 to a secondary flow duct or bypass duct B. The bypass duct B here runs around a core engine comprising the compressor V and the turbine TT and comprising a primary flow duct for the air supplied to the core engine by the fan F.

The air conveyed into the primary flow duct by means of the compressor V passes into a combustion chamber portion BKA of the core engine, in which the drive energy for driving the turbine TT is generated. For this purpose, the turbine TT has a high-pressure turbine 113, a medium-pressure turbine 114 and a low-pressure turbine 115. Here, the energy released during the combustion is used by the turbine TT to drive the rotor shaft S and thus the fan F in order to generate the required thrust by means of the air conveyed into the bypass duct B. Both the air from the bypass duct B and the exhaust gases from the primary flow duct of the core engine flow out via an outlet A at the end of the engine T. In this arrangement, the outlet A generally has a thrust nozzle with a centrally arranged outlet cone C.

In principle, the fan F can also be coupled, via the rotor shaft S and an additional epicyclic planetary gear mechanism, to the low-pressure turbine 115 and can be driven by the latter. It is furthermore also possible to provide other, differently designed gas turbine engines in which the proposed solution can be used. For example, engines of this type may have an alternative number of compressors and/or turbines and/or an alternative number of rotor shafts. As an example, the engine may have a split-flow nozzle, meaning that the flow through the bypass duct B has its own nozzle, which is separate from and situated radially outside the core engine nozzle. However, this is not limiting, and any aspect of the present disclosure may also apply to engines in which the flow through the bypass duct B and the flow through the core are mixed or combined before (or upstream of) a single nozzle, which may be referred to as a mixed-flow nozzle. One or both nozzles (whether mixed or split flow) can have a fixed or variable area. While the example described relates to a turbofan engine, the proposed solution may be applied for example to any type of gas turbine engine, such as an open-rotor engine (in which the fan stage is not surrounded by an engine nacelle) or a turboprop engine.

FIG. 5 shows a longitudinal section through the combustion chamber portion BKA of the engine T. This shows in particular an (annular) combustion chamber BK of the engine T. A nozzle assembly is provided for the injection of fuel or an air-fuel mixture into a combustion space 23 of the combustion chamber BK. Said nozzle assembly comprises a combustion chamber ring, on which multiple fuel nozzles 17 are arranged along a circular line around the central axis M. Here, on the combustion chamber ring, there are provided the nozzle outlet openings of the respective fuel nozzles 17 which are situated within the combustion chamber BK. Here, each fuel nozzle 17 comprises a flange by means of which a fuel nozzle 17 is screwed to an outer casing 22 of the combustion chamber portion BKA.

FIG. 6, in a further enlarged scale compared with FIG. 5 and in sectional view, shows a combustion chamber BK known from the prior art and in particular the configuration provided here of a burner seal 4 and a heat shield 2 in the region of a combustion chamber head 3 of the combustion chamber BK. The illustrated combustion chamber BK is in this case for example a (fully) annular combustion chamber such as is used in gas turbine engines.

The combustion chamber BK is arranged in the interior of the outer casing 22. The combustion chamber BK comprises, as combustion chamber components, a combustion chamber structure surrounding the combustion space 23, (radially) outer and (radially) inner combustion chamber walls 1a and 1b. These combustion chamber walls 1a, 1b are, depending on construction, shielded from the combustion space 23 in some cases with shingle components in the form of combustion chamber shingles 6. These combustion chamber shingles 6 may for example each be connected to the inner and outer combustion chamber walls 1a, 1b by means of fixing elements in the form of bolts 10 and nuts 11. The combustion chamber walls 1a and 1b normally have cooling holes 12 and supply openings in the form of mixing air holes 7. A combustion chamber shingle 6 may also be provided with effusion cooling holes 13. An outer combustion chamber wall 1a is connected to the outer casing 22 via an arm 8 and a flange 9.

A combustion chamber head 3, with a further combustion chamber component of the combustion chamber structure in the form of a head plate 5, is provided in a front end of the combustion chamber BK relative to a longitudinal axis L. The outer and inner combustion chamber walls 1a and 1b are connected together via this combustion chamber head 3 and the head plate 5. The head plate 5 shown here comprises cooling holes 15. Furthermore, a supply opening 26 is formed on the head plate 25 which provides access to the combustion space 23 and in which the fuel nozzle 27 is provided.

A burner seal 4 ensures the positioning of the fuel nozzle 27 in the head plate 5, and in particular in the supply opening 26 of the head plate 5. The burner seal 4, which may also be provided with cooling holes 16, is here mounted in floating fashion and, in the illustrated embodiment variant from the prior art, is positioned on the head plate 5 by means of a front positioning part in the form of a front positioning ring 24, and by means of a rear positioning part in the form of a rear positioning ring 28. Furthermore, the burner seal 4 is bolted to a heat shield 2 lying in the combustion space 23. For this, the heat shield 2 forms fixing elements in the form of bolts 17 which are guided through fixing openings on the head plate 5 and screwed on to the nuts 11 from the side of the combustion chamber head 3. Access for mounting the nuts 11 is provided via holes 19 in the combustion chamber head 3. According to the depiction in FIG. 6, the heat shield 2 may also have cooling air holes 14 and cooling ribs or studs. The bolts 17 may also be designed as separate components and therefore may not be formed by the heat shield 2. Such bolts 17 are then for example screwed into threaded openings of the heat shield 2 from the side of the combustion chamber head 3.

FIG. 7 shows, on an enlarged scale and in a cross-sectional view, a configuration of a mixing air hole 7 known from the prior art in relatively great detail. Here, the mixing air hole 7 is formed by a through hole 100a in the outer combustion chamber wall 1a illustrated by way of example and by a shingle through hole 67′ in the combustion chamber shingle 6. In this arrangement, the through hole 100a and the shingle hole 67′ are arranged concentrically with one another along a central axis Z. Both holes 100a and 67′ are furthermore defined by a right circular cylinder and thus extend perpendicularly to a flow direction s along which mixing air is guided along the outer side of the combustion chamber wall 1a to the mixing air hole 7.

On the outer side of the combustion chamber wall 1a, the through hole 100a in the combustion chamber wall 1a defines an inflow opening 101a, via which mixing air can flow into the mixing air hole 7 in the direction of the combustion space 23. In the case of the combustion chamber assembly known from the prior art, the inflow opening 101a has a diameter d1 which is larger than a diameter d2 of the shingle hole 67′. Owing to the larger diameter d1 of the through hole 100a in the wall, at least a portion of an edge surface 673′ of a projecting shingle edge 67a′, in which the shingle hole 67′ in the combustion chamber shingle 6 is formed, is not covered by the combustion chamber wall 1a on the cold side of the combustion chamber shingle 6. Thus, the edge surface 673′ which borders the shingle hole 67′ on the cold side is exposed over the full circumference at the shingle hole 67′ and forms a single-step transition from the through hole 100a to the shingle hole 67′.

In practice, it has been found that, in the case of a combustion chamber assembly corresponding to FIG. 7, there may be separation of a mixing air flow on that side of the mixing air hole 7 which faces the combustion chamber head 3 (at a left-hand inner wall of the shingle hole 67, in the region of the transition to the hot side, in the sectional illustration in FIG. 7). As a result, it is possible, in turn, that a flame from the combustion space 23 may penetrate as far as the edge of the shingle hole 67′ and, in the process, may oxidize the inner wall of the shingle hole 67′ relatively rapidly. This, in turn, limits the life of the combustion chamber shingle 6, in some cases considerably.

In the case of a combustion chamber assembly according to the proposed solution, the risk of separation of the mixing air flowing out of the mixing air hole 7 is reduced and hence oxidation or overheating in the region of a shingle hole is reduced, this being associated with an increase in the life of the combustion chamber shingle 6.

Here, FIG. 1 shows, in a cross-sectional view corresponding to FIG. 7, the configuration of a mixing air hole 7 according to the proposed solution with holes 100a and 67 provided eccentrically relative to one another in the (combustion chamber) wall and in the shingle. Thus, here, the through hole 100a in the combustion chamber wall 1a is provided eccentrically with respect to a shingle hole 67 in the combustion chamber shingle 6. A central point M101a of the inlet opening 101a of the through hole 100a is thus offset with respect to a central point M671 of an outlet opening 671 of the shingle hole 67. In the present case, the central point M671 of the outlet opening 671, provided on the hot side, of the combustion chamber shingle 6 is offset in the flow direction s of the mixing air flow with respect to the central point M101a of the inflow opening 101a. Consequently, there is an offset transversely to the central axis Z in spatial direction y.

The resulting asymmetry within the mixing air hole 7 takes account of the asymmetry of the mixing air inflow and reduces the risk of separation of the mixing air flow as it emerges on the hot side of the combustion chamber shingle 6. In this arrangement, the through hole 100a and the shingle hole 67 are furthermore each defined substantially by a right cylinder, although the central axes of the cylinders are deliberately offset relative to one another.

The cross-sectional area of the inflow opening 101a in the combustion chamber wall 1a is furthermore of elliptical configuration, while the cross-sectional area of the outflow opening 671 of the shingle hole 67 is of circular configuration. Here, the dimensions of the elliptical inflow opening 101a, in particular the lengths of the principal and secondary axes of the elliptical base area, are larger than the diameter of the circular outlet opening 671. As a result, there is an encircling edge surface 673 on the cold side of the combustion chamber shingle 6, in the region of the through hole 11a, and this edge surface is not covered by the combustion chamber wall 1a at projecting shingle edge sections 67a and 67b of the combustion chamber shingle 6. At a second end of the mixing air hole 7 (illustrated on the right in FIG. 1), which is situated downstream—relative to the flow direction s—in the cross-sectional view in FIG. 1, the edge surface 673 has a narrow width b2. In contrast, the width of the edge surface 673 is greater at an upstream first end. The width of the edge surface 673 and of a transition defined thereby from the through hole 100a to the shingle hole 67 consequently decreases on the cold side along the circumference of the shingle hole 67.

Furthermore, an asymmetric funnel contour is formed by a feed bevel in the form of a chamfer 672 at one edge of an inlet opening 670 of the shingle hole 67. By means of this chamfer 672 and an inwardly beveled guide surface formed thereby, mixing air is guided out of the through hole 100a in the wall in the direction of the outlet opening 671, with the result that the mixing air flow can cling well to the contour of an inner wall 674 of the shingle hole 67. In this arrangement, the chamfer 672 is provided in such a way as to run at least part way around the circumference of the inlet opening 670 of the shingle hole 6. Here, the width of the chamfer 672 is not constant along the circumference of the inlet opening 670. On the contrary, the chamfer 672 has a maximum width in the region of the upstream first end in accordance with the cross-sectional view in FIG. 1. Starting from this first end close to the combustion chamber head, the width of the chamfer decreases along the circumference of the inlet opening 670 and, for example, may decrease continuously, in particular may taper toward the second end.

By way of the chamfer 672, the cross-sectional view in FIG. 1 also illustrates the increased width and asymmetry of the shingle hole 67 in the region of the inlet opening 670 thereof, in comparison with the configurations known from the prior art shown in FIG. 7. Thus, FIG. 1 illustrates the constant diameter of the shingle hole 67′ of FIG. 7 provided concentrically with the through hole 100a in the wall. By virtue of the eccentric arrangement in the combustion chamber assembly in FIG. 1, corresponding to the proposed solution, a significantly gentler transition to the shingle hole 67 along a wall section with a width b10 is provided at the first, upstream end and in an inflow region provided here.

In the design variant illustrated, an upstream section of an inner wall 674 of the shingle hole 67 is furthermore designed in such a way that, in an upstream edge region of the outlet opening 671, this inner wall 674 assumes an acute angle α relative to an edge surface bounding the outlet opening 671 on the hot side of the combustion chamber shingle 6. The inner wall 674 of the shingle hole 67 and an edge surface of the outlet opening 671 thus extend at an acute angle α<90° to one another. This likewise reduces the risk of separation of the mixing air flow at the outlet from the mixing air hole 7 at the edge of the outlet opening 671 close to the combustion chamber head.

Further details of a design variant of a proposed combustion chamber assembly are illustrated by means of the sectioned perspective view in FIG. 3. Here, FIG. 3 shows, in particular, a rounded portion 102a which runs around the entire circumference at the edge of the inflow opening 101a of the combustion chamber wall 1a and via which the mixing air is guided in the direction of the shingle hole 67. This rounded portion is present, in particular, on an inflow side of the mixing air hole 7, but, as shown in FIG. 3, it can also extend over the entire circumference of the inflow opening 101a.

In the design variant in FIG. 3, the width of the edge surface 673 forming the transition to the shingle hole 67 decreases continuously from a maximum width b1 provided upstream to a minimum width b2 situated downstream. In a similar way, a chamfer 672 provided on the inlet opening 670 of the shingle hole 67 tapers from a maximum width b3 at an upstream end of the shingle hole 67 (based on a central cross-sectional view corresponding to FIG. 1) to a minimum width b4 at a downstream second end. By means of the corresponding asymmetry and eccentric arrangement, the effective, separation-free guidance of the mixing air through the mixing air hole 7 toward the combustion space 23 is assisted in this case too.

In this context, it has proven advantageous that the maximum width b1 of the edge surface 673 and hence of the overhang in the transitional region from the through hole 100a to the shingle hole 67 is at least twice a wall thickness a of the combustion chamber wall 1a. Here, furthermore, the minimum width b2 of the edge surface 673 or of the overhang formed thereby at the downstream second end is at least as great as the wall thickness a of the combustion chamber wall 1a.

The illustrated contouring and eccentric arrangement of the through hole 100a in the wall and of the shingle hole 67 in the shingle can moreover also be provided in the case of a mixing air hole 7 in the region of a spark plug of the combustion chamber BK. If an access opening for the spark plug then overlaps with this mixing air hole 7 and a kind of keyhole contour is formed as a result, the overhang of the combustion chamber shingle 6 with the edge surface 672 beyond the edge of the inflow opening 101a is, in this case too, greater at the upstream first end than at the downstream end of the keyhole formed (in each case based on the flow direction s along the outer side of the combustion chamber wall 1a and thus parallel to spatial direction y in FIG. 6).

### LIST OF REFERENCE SIGNS

1a, 1b (Outer/inner) combustion chamber wall
10 Bolt (fixing element)
100a Through hole
101a Inflow opening
102a Rounded portion
11 Nut
111 Low-pressure compressor
112 High-pressure compressor
113 High-pressure turbine
114 Medium-pressure turbine
115 Low-pressure turbine
12 Cooling hole
13 Effusion cooling hole
14 Cooling air hole
15 Cooling hole
16 Cooling hole
17 Bolt (fixing element)
19 Hole
2 Heat shield (shingle component)
22 Outer casing
23 Combustion space
24 Front positioning ring
26 Through hole (through opening)
27 Fuel nozzle
28 Rear positioning ring
3 Combustion chamber head
4 Burner seal
5 Head plate (combustion chamber component)
6 Combustion chamber shingle (shingle component)
67, 67′ Shingle hole
670 Inlet opening
671 Outlet opening
672 Chamfer (feed bevel)
673, 673′ Edge surface
674 Inner wall
67a, 67b Shingle edge section
67a′ Shingle edge
7 Mixing air hole
8 Arm
9 Flange
A Outlet
a Wall thickness
B Bypass duct
b1, b2, b10 Width
b3, b4 Chamfer width
BK Combustion chamber
BKA Combustion chamber portion
C Outlet cone
d1, d2 Diameter
E Inlet/Intake
F Fan
F1, F2 Fluid flow
FC Fan casing
L Longitudinal axis
M Central axis/axis of rotation
M101a Central point of inflow opening
M671 Central point of outlet opening
s Flow direction
S Rotor shaft
T (Turbofan) engine
TT Turbine
V Compressor
Z Central axis
α Angle

1. A combustion chamber assembly for an engine, with at least
one combustion chamber component of a combustion chamber structure surrounding a combustion space, and
one shingle component fixed on the combustion chamber component and having a hot side facing toward the combustion space and a cold side facing away from the combustion space and toward the combustion chamber component,
wherein the combustion chamber assembly has at least one mixing air hole for feeding mixing air into the combustion space, which hole is formed by a through hole in the combustion chamber component and a shingle hole in the shingle component, wherein the through hole defines an inflow opening for mixing air on an outer side of the combustion chamber component, and, on the hot side, the shingle hole defines an outlet opening for mixing air flowing in via the inlet opening,
wherein
the through hole in the combustion chamber component is provided eccentrically with respect to the shingle hole in the shingle component, based on a central point of the outlet opening.

2. The combustion chamber assembly according to claim 1, wherein the central point of the outlet opening is offset relative to a central point (M101a) of the inflow opening in a flow direction in which mixing air is guided along the outer side of the combustion chamber component during the operation of the engine.

3. The combustion chamber assembly according to claim 1, wherein the inflow opening is elliptical, and/or the outlet opening is circular.

4. The combustion chamber assembly according to claim 1, wherein the through hole is defined geometrically by a right cylinder, and the shingle hole is likewise defined by a right cylinder.

5. The combustion chamber assembly according to claim 1, wherein the dimensions of the inflow opening are larger than the dimensions of an inlet opening defined by the shingle hole on the cold side of the shingle component, and, as a result, on the cold side of the shingle component, an edge surface, bounding the inlet opening, of the shingle component is at least in part not covered by the combustion chamber component at the inflow opening.

6. The combustion chamber assembly according to claim 5, wherein the edge surface of the shingle component which is not covered by the combustion chamber component at the inflow opening has a greater width in an upstream region, based on a flow direction in which mixing air is guided along the outer side of the combustion chamber component during the operation of the engine, than in a downstream region.

7. The combustion chamber assembly according to claim 6, wherein the edge surface which is not covered by the combustion chamber component has an upstream first end and a downstream second end in a central cross section through the mixing air hole, and the edge surface which is not covered has its maximum width at the upstream end.

8. The combustion chamber assembly according to claim 7, wherein the width of the edge surface which is not covered decreases (continuously) in a circumferential direction along the edge of the inlet opening from the first end to the second end.

9. The combustion chamber assembly according to claim 7, wherein the width of the edge surface which is not covered corresponds at the first end to at least twice a wall thickness of the combustion chamber component at the through hole, and/or the width of the edge surface which is not covered at the second end corresponds to at least a wall thickness of the combustion chamber component at the through hole.

10. The combustion chamber assembly according to claim 1, wherein, on the cold side of the shingle component, the shingle hole defines an inlet opening, at which mixing air can flow out of the through hole in the combustion chamber component into the shingle hole in the direction of the outlet opening, and a feed bevel that guides a mixing air flow in the direction of the outlet opening is formed on one edge of the inlet opening.

11. The combustion chamber assembly according to claim 10, wherein the feed bevel has a greater width in an upstream region, based on a flow direction in which mixing air is guided along the outer side of the combustion chamber component during the operation of the engine, than in a downstream region.

12. The combustion chamber assembly according to claim 10, wherein the feed bevel is provided in such a way as to run around the circumference of the inlet opening of the shingle hole.

13. The combustion chamber assembly according to claim 12, wherein the feed bevel has an upstream first end and a downstream second end in a central cross section through the mixing air hole, and the feed bevel has its maximum width at the upstream end.

14. The combustion chamber assembly according to claim 10, wherein a width of the feed bevel decreases in a circumferential direction along the edge of the inlet opening.

15. The combustion chamber assembly according to claim 13, wherein the width of the feed bevel decreases in the circumferential direction from the first end to the second end.

16. The combustion chamber assembly according to claim 1, wherein, in a central cross section through the mixing air hole, an upstream section of an inner wall of the shingle hole and an edge surface bounding the outlet opening on the hot side of the shingle component extend at an acute angle to one another in an upstream edge region of the outlet opening.

17. The combustion chamber assembly according to claim 1, wherein a rounded portion, which guides mixing air in the direction of the shingle hole, is formed on one edge of the inflow opening.

18. A combustion chamber assembly for an engine, with at least
one combustion chamber component of a combustion chamber structure surrounding a combustion space, and
one shingle component fixed on the combustion chamber component and having a hot side facing toward the combustion space and a cold side facing away from the combustion space and toward the combustion chamber component,
wherein the combustion chamber assembly has at least one mixing air hole for feeding mixing air into the combustion space, which hole is formed by a through hole in the combustion chamber component and a shingle hole in the shingle component,
wherein the through hole defines an inflow opening for mixing air on an outer side of the combustion chamber component, and
wherein, on the hot side, the shingle hole defines an outlet opening for mixing air flowing in via the inlet opening, and, on the cold side, the shingle hole defines an inlet opening, at which mixing air can flow out of the through hole in the combustion chamber component into the shingle hole in the direction of the outlet opening,
wherein
a feed bevel, which guides a mixing air flow in the direction of the outlet opening, is formed on one edge of the inlet opening in the shingle component, which bevel has a greater width in an upstream region, based on a flow direction in which mixing air is guided along the outer side of the combustion chamber component during the operation of the engine, than in a downstream region.

19. An engine with a combustion chamber assembly according to claim 1.
